(19) United States
(12) Patent Application Publication
(10) Pub. No.: US 2026/0237258 A1
(43) Pub. Date: Aug. 13, 2026

(54) LOCKING DEVICE AND METHOD FOR SECURING INVENTORY

(71) Applicant: Target Brands, Inc., Minneapolis, MN (US)

(72) Inventors: Ethan Sommer, Minneapolis, MN (US); Todd A. Hagen, Shakopee, MN (US); Jason Michael Kadrmas, Lauderdale, MN (US); Gabrielle Bigalke, New York, NY (US); Raghavendra Deshpande, Minneapolis, MN (US)

(21) Appl. No.: 19/049,861

(22) Filed: Feb. 10, 2025

(51) Int. Cl. G07C 9/00; H04L 9/32

(52) U.S. Cl. CPC G07C 9/00174; H04L 9/3247; G07C 2009/00769

(57) ABSTRACT

In some implementations, systems and methods for securing using a locking device, can include receiving, at a locking device, a first secure certificate that includes a time window from a mobile device using a wireless network connection. Receiving, at the locking device, time information from the mobile device. Authenticating the first secure certificate by the locking device. Determining, by the locking device, that the time information corresponds with the time window. Determining, by the locking device, that the time information is after a threshold time based on a prior unlock time. Unlocking the locking device.

### TECHNICAL FIELD

This specification generally relates to locking technology for securing inventory for retail stores.

### BACKGROUND

Retail stores, in general, provide customers access to inventory on a sales floor. From the sales floor, customers pick items from shelving for purchase. Some retail items are locked out of reach of customers often due to theft or crime such as organized retail crime. To purchase locked goods, the goods are manually unlocked with physical keys and provided to shopping customers. Manually unlocking inventory can be time consuming, delay the purchasing of goods, and can create a worsened customer experience.

### SUMMARY

This document generally describes systems and processes for a locking device, that can be unlocked using a mobile device, for securing items (e.g., inventory) secured in a case (e.g., an inventory case).

In some implementations, a method for the disclosed technology can include receiving, at a locking device securing an inventory case, a first secure certificate, that includes a time window, from a mobile device using a wireless network connection. The method further includes receiving, at the locking device, time information from the mobile device. The method further includes authenticating the first secure certificate by the locking device. The method further includes determining, by the locking device, that the time information corresponds with the time window. The method further includes determining, by the locking device, that the time information is after a threshold time based on a prior unlock time for the locking device. The method further includes unlocking the locking device allowing access to the inventory case.

In some implementations a locking device can be used for securing inventory. The locking device includes one or more processors. The locking device includes computer-readable memory. The computer-readable memory stores instructions that, when executed by the processors, cause the processors to perform operations including receiving, at the locking device, a first secure certificate, that includes a time window, from a mobile device using a wireless network connection. The operations further include receiving, at the locking device, time information from the mobile device. The operations further include authenticating the first secure certificate by the locking device. The operations further include determining, by the locking device, that the current time information corresponds with the time window. The operations further include determining, by the locking device, that the time information is after a threshold time based on a prior unlock time for the locking device. The operations further include unlocking the locking device.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. Establishing a wireless connection with the mobile device. The locking device does not include a clock. Sending, to the mobile device, unlock log information for a number of previous unlocking events for the locking device, wherein the unlock log information includes identification information and unlock time information for each of the number of previous unlocking events. The prior unlock time is stored at the locking device based on a prior unlocking event. In some implementations, an unlocking event for a locking device can include an unlocking of the locking device using one or more secure certificates and time information used for unlocking the locking device. Logging the unlocking of the locking device, wherein the logging includes storing identification information and unlock time information at the locking device. Relocking the locking device based on determining that the inventor case has been accessed. Authenticating the first secure certificate includes using a public key to verify an encrypted digital signature. The prior unlock time is based on the time window included in the secure certificate. Requesting the first secure certificate based on a proximity of the mobile device to a store. Requesting a plurality of secured certificates based on the proximity of the mobile device to a store, wherein the first secured certificate is included in the plurality of secured certificates. Sending, by a server, the secure certificate to the mobile device based on a trust assessment. Sending, to the mobile device, unlock log information for a number of previous unlocking events for the locking device, wherein the unlock log information includes identification information and unlock time information for each of the number of previous unlocking events. Based on the unlock log information, denying unlock access to an untrusted mobile device. The trust assessment includes correlating an activity with an inventory case. The trust assessment includes correlating a risk level with an inventory case. The time window is based on the trust assessment.

The systems, devices, program products, and processes described throughout this document can, in some instances, provide one or more of the following advantages. In some implementations, automatically unlocking a locking device using a user mobile device can be efficient such that it can take less time and/or effort than manually unlocking a case. In some implementations, unlocking a locking device using a user mobile device can allow for various levels of security based on inventory and/or users. Other features, aspects and potential advantages will be apparent from the accompanying description and figures.

### DESCRIPTION OF DRAWINGS

FIG. 1 shows a diagram of an exemplary system for securing a case using a locking device.

FIG. 2A shows a diagram of an exemplary unlocking event of a locking device.

FIG. 2B shows a diagram of a locking device logging an unlocking event.

FIG. 3 shows a diagram of an exemplary process for evaluating a rule set of a locking device.

FIG. 4 is a diagram that shows an exemplary timeline for unlocking requests for a locking device for securing inventory.

FIG. 5 is a diagram that shows an exemplary process for unlocking a locking device for securing an inventory case.

FIG. 6 is a diagram that shows an exemplary system for securing inventory using a locking device.

FIG. 7 is a diagram that shows an exemplary process for unlocking a locking device for securing inventory.

FIG. 8 is a diagram that shows an example of receiving authentication credentials based on a proximity to a retail store.

FIG. 9 shows a diagram of an exemplary process for a trust assessment for determining access to unlocking credentials.

FIG. 10 is a schematic diagram that shows an example of a computing system.

Like reference symbols in the various drawings indicate like elements.

### DETAILED DESCRIPTION

This document describes technology for a locking device capable of being unlocked using time limited authentication credentials provided from a mobile device that can secure a case (e.g., an inventory case). Clocks can be difficult to implement in a lock for example in a lock that secures inventory in a retail store due to various constraints including powering the lock. In some implementations, for example in a retail setting, allowing users (e.g., customers, employees, workers, etc.) to use a mobile device to have time limited access to inventory in inventory cases secured with a locking device without a clock can be beneficial. In some implementations, users can access inventory secured in inventory cases using a mobile device they have with them allowing quick access to the inventory without having another person unlock the inventory for them.

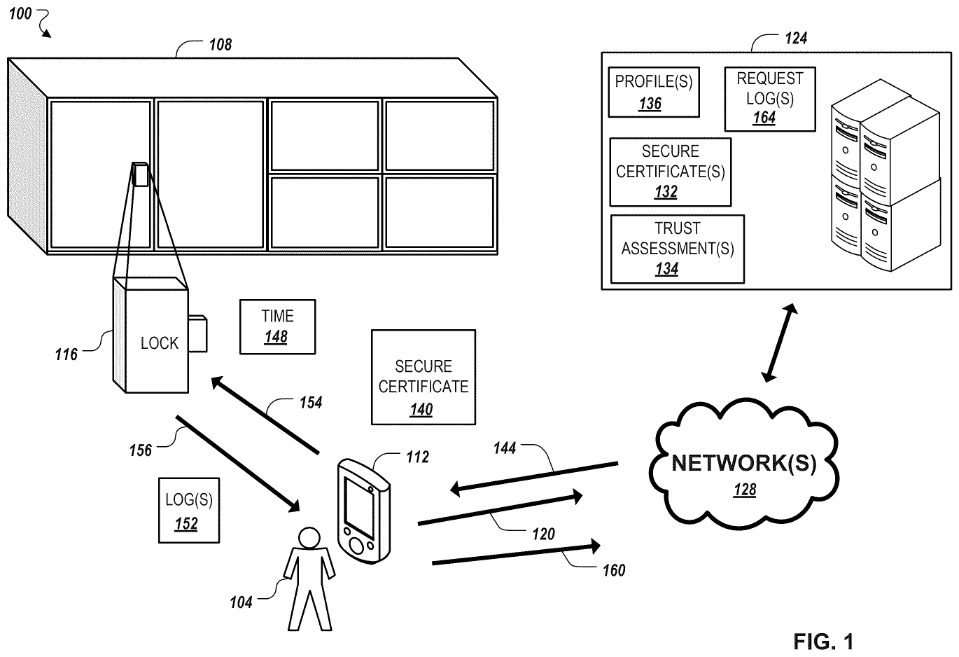

FIG. 1 shows a diagram of an exemplary system 100 for securing a case 108 using a locking device 116. In the exemplary implementation of FIG. 1, a user 104, for example in a retail store, wanting to access one or more items (e.g., inventory) in a closed and locked case 108 (e.g., inventory case, etc.) has a mobile device 112 within close proximity of the locking device 116 that is locking the case 108. In the exemplary implementation, the mobile device 112 sends an unlock request 120 to a trusted server 124 through a network connection using one or more networks 128. The unlock request 120 for example can request one or more secure certificates 132 for unlocking one or more locking devices such as locking device 116. The trusted server 124 can be locally or remotely located from the retail store. The trusted server 124 can be used to unlock inventory at one or more locations such as one or more retail stores. The trusted server 124 can conduct one or more trust assessments 134 of the user 104 associated with the requesting mobile device 112 using one or more user profiles 136 associated with the user 104. For example, the server 124 can determine if the user 104 is a trusted person that can be allowed access to automatically unlock the case 108 associated with the locking device 116. In some implementations of a trust assessment, if the user is not determined to be a trusted person based on a user profile, then the unlock request can be denied and the case is not unlocked and the user will not be allowed access to inventory in the case. In some implementations of a trust assessment, if the user is determined to be a trusted person based on a user profile, then the unlock request can be granted and unlocking information can be sent to the mobile device for unlocking the lock 116.

In the example of FIG. 1, the trusted server 124 sends a secure certificate 140 to the mobile device 112 using one or more networks 128 as shown at 144. The secure certificate 140 can be cryptographically secured using encryption. For example, trusted server 124 can use a private key to sign the secure certificate 140 using an encrypted digital signature that can be verified using a public key. The secured certificate 140, for example, can include identification information. For example, the identification information can include information identifying the user 104 associated with the unlock request that the secure certificate was sent as a response. The secure certificate 140, for example, can include information about a validity period that indicates a time window when the secure certificate can be used to unlock the locking device 116. For example, the validity period can be set for an appropriate amount of time to limit the users access to open the inventory case. In some implementations, the user can be a customer, for example, shopping at the retail store and the validity period can be set for a time window that would be appropriate for a shopping session for the customer to access inventory during the shopping session. In another implementation, the user can be an employee working at the retail store and the validity period can be set for a time window that would be appropriate for the employee to open the inventory case while working at the retail store. The mobile device 112 can establish a wireless network connection to the locking device 116 and send the secure certificate 140 and time information 148 to the locking device 116 as shown at 154. The time information 148 can include a time stamp from the mobile device that indicates a current time. The locking device 116 can use the secure certificate 140 and the time 148 to evaluate a rule set at the locking device 116 to determine if the locking device can unlock or not unlock the case 108. In some implementations, the rule set to be evaluated can include a rule to authenticate the secure certificate, a rule to determine if the time information from the mobile device corresponds to a validity time window, a rule to determine if the time information from the mobile device corresponds to a time after a threshold time based on a prior unlock time, or other rule. In some exemplary implementations, for the locking device to unlock, the locking device can determine that each of the rules is evaluated appropriately for unlocking before the locking device unlocks. For example, in some implementations, if one or more of the rules are evaluated and determined to not allow the locking device to unlock then the locking device will not unlock based on that evaluation.

In the exemplary implementation of FIG. 1, in determining if the case 108 can be unlocked for the user, the locking device 116 can authenticate the secure certificate 140 to determine if it has been provided by the trusted server 124. For example, because the secure certificate 140 was provided to the locking device 116 by the mobile device 112 and not sent directly from the trusted server 124, the locking device can verify that the secure certificate 140 was provided by the trusted server 124 by using cryptographic information. In some implementations, the secure certificate is authenticated using a public key from the trusted server stored at the locking device to validate the digital signature that is included in the secure certificate. In the example, of FIG. 1, the locking device 116 authenticates the secure certificate as authentically provided by the secure server 124.

In the exemplary implementation of FIG. 1, in determining if the case 108 can be unlocked for the user, the locking device 116 can determine if the time information 148 corresponds to a time within a time window provided in the secured communication of the secure certificate 140. For example, the secure certificate can include information designating a window of time when the secure certificate is valid to be used to unlock the locking device 116 and allowing the user 104 access to the case 108 and can compare the time information to the time window to determine if the time is within the time window. In the example, of FIG. 1, the locking device 116 can determine that the time information 148 corresponds to a time within the time window provided in the secured communication of the secure certificate 140.

In the exemplary implementation of FIG. 1, in determining if the case 108 can be unlocked for the user, the locking device 116 can determine if the time provided in the time information is after a threshold time based on a prior unlocking event. For example, the time information can be compared to a threshold time set based on the time information logged from the last unlocking of the locking device to determine if the time is after the threshold time or before the threshold time. In the example, of FIG. 1, the locking device 116 can determine that the time information 148 corresponds to a time after the threshold time set based on the time of the last unlocking of the locking device. As the locking device 116, for example, does not include an internal clock, the locking device can use the time information provided by the mobile device to determine a progression in time. For example, the locking device 116 can store the time information it used in a prior unlocking and compare to later provided times to determine if the later provided time is a time after the prior unlocking. In some implementations, comparing one or more previously stored times to a received current time can prevent unauthorized devices from using outdated credentials such as old secure certificates with a counterfeited time to unlock cases secured by a locking device.

In the exemplary implementation of FIG. 1, based on the successful evaluation of the rule set, the lock 116 unlocks and allows the user 104 access to the unlocked case 108. The user 104 can open the case 108 to retrieve one or more items (e.g., inventory) stored in the case and close the case 108. After the case 108 is closed, the locking device determines that the case 108 has been closed after being opened and automatically relocks the case 108. After unlocking, the locking device can log the unlocking event and send a number of logs 152 of prior logged unlocking events to the mobile device 112 as shown at 156. The mobile device 112 can then send the number of logs 152 of prior unlocking events to the trusted server 124 as shown at 160. The trusted server 124 can use the received number of logs 152 to compare with one or more logs 164 that can include logs that have been previously received from prior unlocking events for the locking device 116. The trusted server 124 can use the comparison of prior logs with the currently received logs to correlate mobile devices that have not transmitted prior logs with associated users and/or untrusted mobile devices. For example, a mobile device that is identified to have failed to transmit unlocking logs can be identified as an untrusted device.

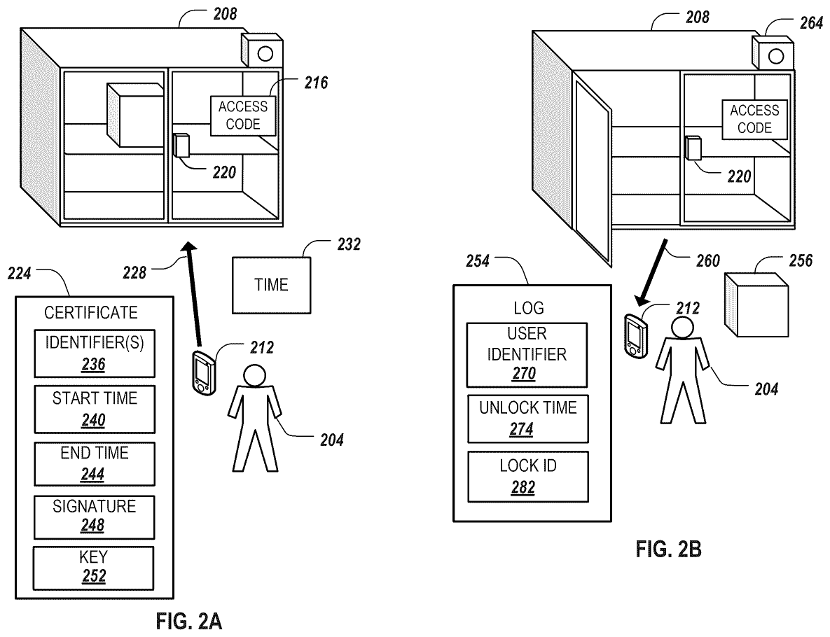

FIG. 2A shows a diagram of an exemplary unlocking event of a locking device. In the example of FIG. 2A, a user 204 wanting access to the locked inventory case 208, can initiate an unlock request. In any of the examples herein, an inventory case can include secured shelving, a cabinet, a case, a locker, a bin, or other secured storage resource. The user 204, for example, can use mobile device 212 and the access code information 216 near the locking device 220 to begin unlocking the locking device. In some implementations, the access code information can be a sign (e.g., sticker, poster, image, etc.) near the locking device that includes information (e.g., QR code, data matrix coder, barcode, internet address, or the like) to allow the user to unlock the inventory cabinet using the mobile device. The access code information 216 can provide information indicating how it can be used to unlock the inventory case 208. In the example of FIG. 2A, the mobile device 212 can use a QR code scanner application to scan the quick-response code (QR code) included in the sticker for the access code information 216 to make an unlock request to a trusted server. In some implementations, the mobile device 212 can include a camera that can be used to scan the access code information 216 in the process to unlock the locking device 220. For example, a camera of the mobile device can be used to scan a QR code to make an unlock request to a trusted server. In some implementations, the mobile device 212 can include a laser barcode scanner that can be used to scan the access code information 216 in the process to unlock the locking device 220. For example, a laser barcode scanner of the mobile device can be used to scan a barcode to make an unlock request to a trusted server. The mobile device 212 can receive a secure certificate 224 from the trusted server and send the secure certificate 224 and time information 232 to the locking device 220 using a wireless connection as shown at 228. In some implementations, the locking device 220 can monitor for wireless connections to mobile devices within a threshold range. In some implementations, the wireless connection, for example, can include a short-range wireless connection (e.g., Bluetooth®), a connection using Near-Field Communication (NFC), an optical connection (e.g., infrared), or other wireless connection. In some implementations, the time information, for example, can include a time stamp of a current time accessed by the mobile device. The time stamp can be represented in one or more formats including Unix time, coordinated universal time (UTC), or other time format.

In some implementations, the secure certificate 224, for example, can include one or more identifiers 236. For example, the identifiers 236 can include information identifying a user who is issued the secure certificate. In another exemplary implementation, the identifiers 236 can include information identifying an issuer of the secured certificate. In an exemplary implementation, the secure certificate 224 can include information regarding a time window including a start time 240 indicating the beginning of a validity time window and an end time 244 indicating the expiration of the validity time window. In some implementations, the secure certificate can include a digital signature. For example, a trusted server can sign the secure certificate 224 with a digital signature 248 using encryption (e.g., public key encryption, private key encryption, etc.). The secure certificate 224, for example, can include a public key 252 from the trusted server that signed the digital signature 248.

FIG. 2B shows a diagram of the locking device 220 logging an unlocking event. In the exemplary implementation of FIG. 2B, the locking device 220 is unlocked. While the locking device 220 is unlocked, the user 204 can open the inventory case 208 and retrieve the inventory item 256 from the inventory case 208. After unlocking, the locking device 220 can send a number of logs such as log 254 to the mobile device 212 as shown at 260. The logs sent to the mobile device 212 can be an ordered set of the previous unlocking events prior to the current unlocking event. For example, the locking device can send the logs of the last 20 unlocking events that are stored at the locking device 220. In some implementations, the log 254 of the unlocking event for the locking device 220 can include information such as one or more user identifiers 270, an unlock time 274, lock identifier information 282, or other information associated with the unlock event. The user identifier 270, for example, can identify a user who was issued the secure certificate that was used to unlock the locking device 220. The unlock time 274, for example, can include time information that was used to unlock the locking device 220. The lock identifier information 282, for example, can identify the locking device that was unlocked. In some implementations, each unlocking event of the locking device can be recorded by a log that is stored at the locking device. In some implementations, a camera 264 can be used to monitor accesses to the inventory case 208. For example, the camera can record users who take items from the inventory case after it is unlocked. In some implementations, the camera recordings can include time stamps of recorded events that can be compared to time information from unlocking events. For example, a recording of a user accessing an inventory case at specified time can be compared to information from an unlocking event associated with that time to identify the user or mobile device that is associated with that unlocking of the inventory case.

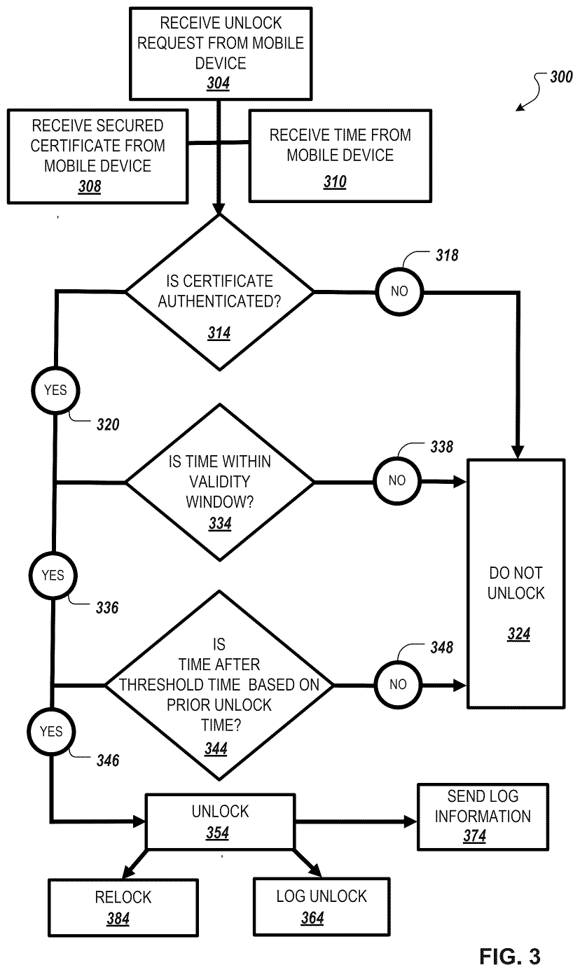

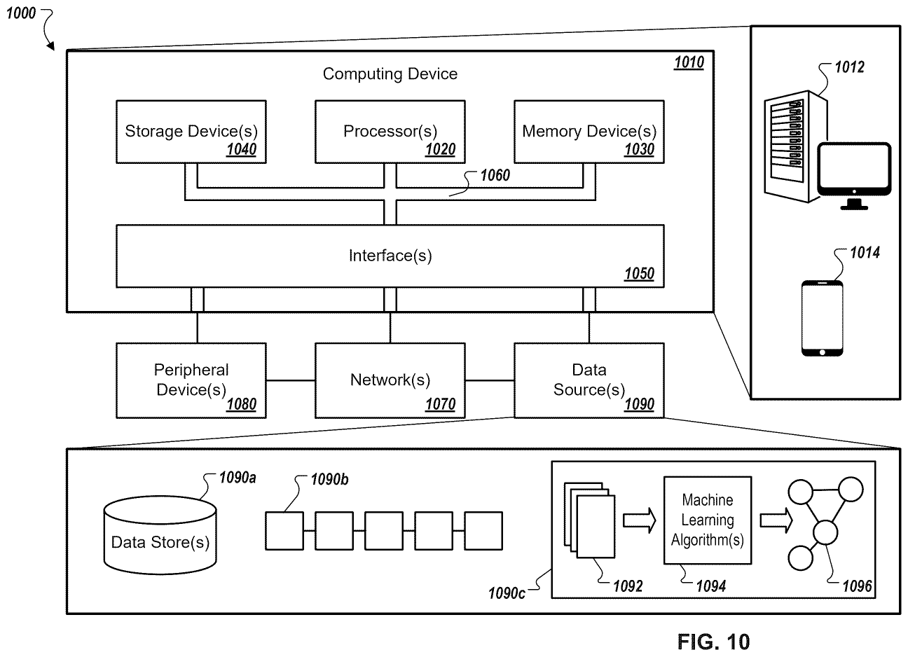

FIG. 3 shows a diagram of an exemplary process 300 for evaluating a rule set of a locking device. For example, a locking device securing inventory in an inventory case. The process 300 can be performed using a locking device coupled to a computing system, as described and depicted herein. For example, the process 300 can be performed including the computing system 1000 in FIG. 10. In the exemplary process 300 an unlock request is received from a mobile device at 304. In some implementations a mobile device can send a request to unlock the locking device that is locking an inventory case and the unlock request can be received at the locking device for evaluation. For example, a customer wanting access to a locked inventory case can send a request to unlock the locking device securing the inventory case through their mobile device and the unlock request can be received at the unlocking device. In some implementations, the mobile device can send a secured certificate and time information along with the unlock request received by the locking device.

At 308, a secured certificate can be received from a mobile device. For example, a mobile device, that makes an unlock request, can receive a secured certificate digitally signed by a trusted server and the mobile device can send the secured certificate to the locking device using a wireless network connection to be used in evaluating the unlock request. In one exemplary implementation, the trusted server can digitally sign the secured certificate using a private key stored by the trusted server. In some implementations, the secured certificate can include information about a time window in which a mobile device of a trusted customer can be granted access to an inventory case secured by the locking device. For example, the secured certificate can include a start time and end time to determine a time window between the start time and end time. In some implementations, the time window can be determined otherwise.

At 310, time information is received from a mobile device. For example, the mobile device can send information for a current time to the locking device. In some implementations the locking device may not have a clock and the mobile device can provide a time corresponding to the time the unlock request was sent to the locking device to indicate a current time that can be used by the locking device to evaluate the unlock request. For example, the mobile device can provide a current time to the locking device when sending an unlock request to be used to evaluate the unlock request. In some implementations, the time information can represent a current time or a time stamp that corresponds to the time the unlock request is made. In some implementations, the time information can include a date, a time of day or other time information.

At 314, the secured certificate is authenticated. In authentication, for example, at the locking device, the cryptographic signature of the secured certificate can be verified to be genuinely issued by a trusted server using cryptographic methods. In one exemplary implementation, by the locking device, the secured certificate can be authenticated through public key encryption by verifying the digital signature in the secured certificate using a public key for the trusted server that is stored at the locking device. The locking device can use the secured certificate and the public key that was issued by the trusted server to verify that the secured certificate was issued and digitally signed by the trusted server and is authentic and trusted for use. In some implementations, the secured certificate can be authenticated using other cryptographic methods. In some implementations, if the secured certificate is authenticated as digitally signed by the trusted server the unlocking process can continue and the information in the digital certificate can be used in the process for unlocking the locking device because the secured certificate was determined to be authenticated as shown at 320. In another implementation, if the secured certificate is determined not to be digitally signed by the trusted server so that it is not authenticated as shown at 318, then the locking device does not unlock as shown at 324. For example, if the secured certificate is not verified as authentic using the public key from the server, the locking device does not unlock as the secured certificate can be deemed untrusted from an untrusted source and not issued from the trusted server. In some implementations, when a decision to not unlock the device is made as shown at 324, the request to unlock the locking device is denied and the lock remains locked based on the failed authentication of the secured certificate. For example, when a secured certificate is received and not authenticated the locking device does not unlock and denies access to the inventory case to the customer trying to access the inventory case. In some implementations, the authentication of the secured certificate can be included as a rule in a set of rules to be evaluated appropriately before the locking device unlocks allowing access to the inventory case.

At 334, a determination is made if the time information received from the mobile device corresponds to a time within a time window. In some implementations, the time information received from the mobile device can be evaluated to determine if the time provided in the time information is within the time window allowable for accessing an inventory case indicated by the received secured certificate. For example, the request time in the time information from the customer's mobile device can be compared to the start time and end time received in the secured certificate to determine if the request time is within the window of time authorized for granting access to the inventory case. In some implementations, if the time information received from the mobile device is determined to correspond to a time within a time window as shown at 336, then the process to for unlocking the locking device can continue. In some implementations, if the provided time information does not include a time that is within the time window as shown at 338, then the locking device does not unlock, as shown at 324, as the time information indicates an access request that is not within the authorized access time restrictions indicated by the trusted server. In some implementations, when a decision to not unlock the locking device is made as shown at 324, the request to unlock the locking device is denied and the locking device remains locked based on the time information not corresponding to an authorized access time window. For example, when the time information provided from the mobile device for the unlock request and the provided time is not within the authorized window of time, then the locking device remains locked denying access to the inventory case to the customer trying to access the inventory case outside of the authorized time. In some implementations, the evaluation of the time information received from the mobile device to determine if the provided time is within the time window can be included as a rule in a set of rules to be evaluated appropriately before the locking device unlocks allowing access to the inventory case. In some implementations, comparing the time information to prior received times can be beneficial to detect counterfeit times sent from mobile devices. In some implementations, the time information, for example, is not secured and the locking device does not have an independent clock to verify the time information, so a rule check based on prior received time information can be used to limit incorrect times at the locking device.

At 344 a determination is made if the time information received from the mobile device corresponds to a time after a threshold time based on a prior unlock time. In some implementations, the time information received from the mobile device can be evaluated to determine if the time provided in the time information is after a threshold time set based on the time information for a prior successful unlock request of the locking device. For example, the locking device can use the time information provided by a mobile device for the last successful unlock request to set a threshold time and compare that threshold time to the current time information provided with the current unlock request to determine if the current time information is after the threshold time. In some implementations the threshold time can be set such that it is a time before the last logged unlock time for the locking device. For example, the threshold time can be set to be a time that is up to the duration of the time window before the last logged unlock time for the locking device. In some implementations, if the time information is determined to correspond to a time that is after the threshold time based on a prior unlock time as shown at 346, then the process for unlocking the locking device can continue. In some implementations, if the time information does not indicate a time that is after the threshold time as shown at 348, then the locking device does not unlock, as shown at 324, as the time information indicates an access request that is not verified to be a trusted current time. For example, if the time provided for the present unlock request is not after the threshold time based on the last unlock time, then the locking device remains locked denying access to the inventory case to the customer trying to access it using unauthorized time information. In some implementations, determining if the time information received from the mobile device corresponds to a time after a threshold time based on a prior unlock time can be included as a rule in a set of rules to be evaluated appropriately before the locking device unlocks allowing access to the inventory case.

At 354, the locking device unlocks. In some implementations, the locking device unlocks automatically based on the applied set of rules for the unlock request. In one implementation, the set of rules for the unlock request can include one or more of the authentication of the secured certificate, determining if the provided time information corresponds to the time window authorized, and determining that the provided time information corresponds to a time after a threshold time. In some implementations, if each of the rules are evaluated and appropriately validated, then the locking device can unlock to allow customer access to an inventory case. In some implementations, the unlocking of the locking device allows access to a case (e.g., inventory case, cabinet, etc.) secured by the locking device. For example, the unlocked locking device can allow a user to open the inventory case to access the inside of the secured case.

At 364, the unlocking event is logged. In some implementations, the time information provided by the mobile device can be recorded and stored as an updated time information. For example, the time received from the mobile device that was used in the unlocking rule procedure for the unlock request can be used as an updated time information. In one exemplary implementation, the locking device does not have an internal clock to determine a current time, so the time information provided by the mobile device used to unlock the locking device can be used by the locking device to store a most recently updated time. The most recently updated time can be used to verify if later unlock requests are later in time or an appropriate time relative to the most recently updated time stored at the locking device. In some implementations, information can be logged for the unlocking event to include the received time information from the mobile device, the secured certificate, identification information for a customer associated with the unlock request, or other information associated with the unlocking event.

At 374, the locking device sends log information to the mobile device. In some implementations, the locking device sends log information for a plurality of prior unlocking events to the mobile device. For example, the locking device can send a log of information for the past 20 unlocking events to the mobile device which can then send the log information to a trusted server. In some implementations, the log information is securely sent to the trusted server using one or more of encryption, a digital signature, or other secured transmission method. At 384, the locking device can automatically relock itself. In some implementations, the locking device can detect that the inventory case has been opened and then been closed so the locking device automatically relocks after the inventory case has been closed.

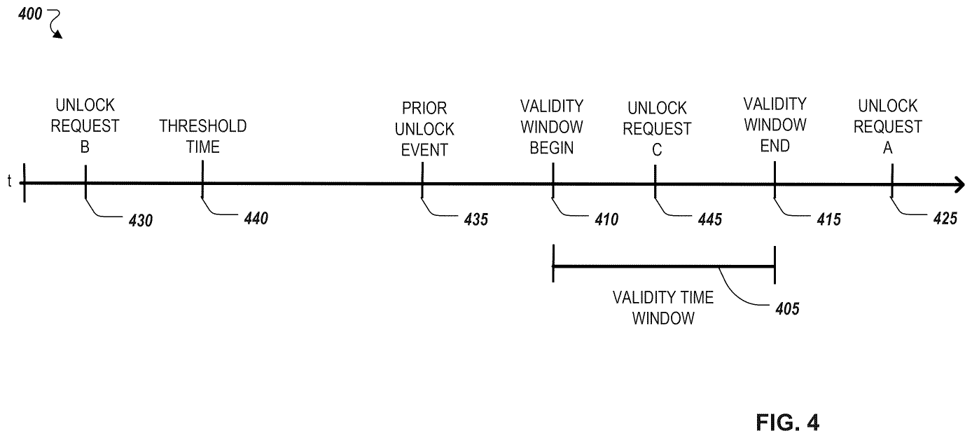

FIG. 4 is a diagram that shows an exemplary timeline 400 for unlocking requests for a locking device for securing inventory. In the exemplary implementation of FIG. 4, an unlocking device has received a secure certificate that includes information for a time window 405 for when the secure certificate can be used to open an inventory case. The time window 405 begins at the time indicated at 410 and the time window 405 expires at the time indicated at 415. A first unlock request is made for the locking device that includes time information indicating by the time shown at 425. As the time shown at 425 is outside of the time window 405, the locking device determines not to unlock for the unlock request. In some implementations, by checking that the time the unlocking is requested with a validity time window can prevent users from using old credentials such as outdated secure certificates to access inventory case. For example, the validity window can limit the amount of time a secure certificate can be used to access an inventory case before a new secure certificate is needed to unlock the inventory case.

In the exemplary implementation of FIG. 4, a second unlock request is made for the locking device that includes time information indicating by the time shown at 430. As the time shown at 430 is outside of the time window 405, the locking device does not unlock. Additionally, as the time shown at 430 is not after the threshold time 440, the locking device determines not to unlock for the unlock request. The threshold time 440 is set based on the time of the last prior unlocking of the locking device shown at 435. In the implementation of FIG. 4, the threshold time 440 can be set such that it is the amount of time of the time window 405 before the last unlocking time shown at 435. In some implementations, as the locking device may not have an independent clock to verify passing of time and to verify time information provided from a mobile device, evaluating if the current time information provided by the mobile device is after a stored threshold time can verify that the credentials (e.g., secure certificate, time information, etc.) used for the unlocking request are not old credentials and correlate to an appropriate time after the last unlocking of the locking device. For example, the locking device can use the times of prior unlocking events to compare to time information received to determine if the received time is after prior unlocking times or if the received time information is a fraudulent or counterfeit time.

In the exemplary implementation of FIG. 4, a third unlock request is made for the locking device that includes time information indicating by the time shown at time 445. As the time shown at time 445 is determined to be within the validity window 405 and after the threshold time 440, the locking device can unlock allowing a user access to the inventory case.

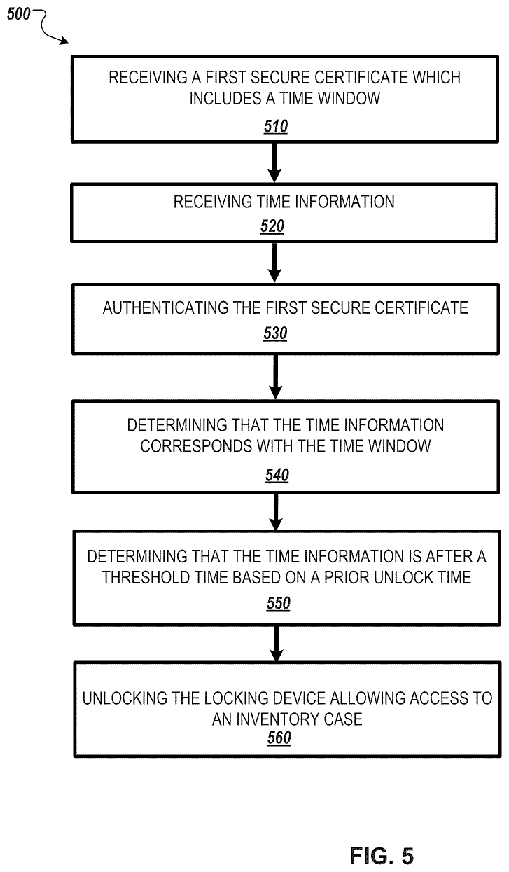

FIG. 5 is a diagram that shows an exemplary process 500 for unlocking a locking device for securing an inventory case. The exemplary process 500 can be performed using a computing system, as described and depicted herein. For example, the process 500 can be performed by the computing system 1000 in FIG. 10. In the exemplary embodiment of FIG. 5, at 510, a first secure certificate that includes a time window is received at a locking device. At 520, time information is received at the locking device. At 530, the first secure certificate is authenticated by the locking device. At 540, it is determined by the locking device if the time information corresponds with the time window. At 550, it is determined by the locking device if the time information is after a threshold time based on a prior unlock time. At 560, the locking device is unlocked allowing access to an inventory case.

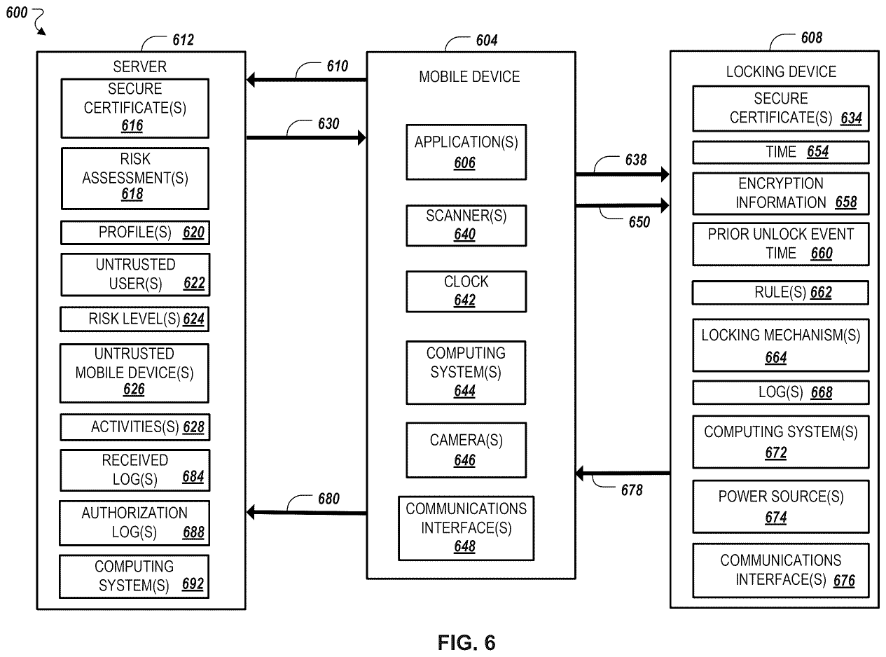

FIG. 6 is a diagram that shows an exemplary system 600 for securing inventory using a locking device. In the exemplary implementation of FIG. 6, a mobile device 604 includes one or more mobile applications 606 and sends a request 610 to a server 612 for authorizing the unlocking of the locking device 608. In some exemplary implementations, the one or more mobile applications 606 include a retail store application, an internet application, an inventory application, or other application for accessing information through a network. In some implementations, the one or more mobile applications 606 can be used to send data to a locking device and/or server as described herein. The server 612 can include one or more computing systems 692 which can be implemented using the computing system 1000 in FIG. 10. In some implementations, one or more networks, for example, can be used to send and receive wireless communications between the server 612 and the mobile device 604. In response to the unlock request 610 the server 612 can generate one or more secure certificates 616. In some implementations, the one or more secure certificates can be generated based on information accessible to and/or stored at the server 612 including but not limited to one or more risk assessments 618, one or more user profiles 620, one or more risk levels 624, one or more activities 628, or other criteria. The server 612 can include information on one or more untrusted users 622 and/or one or more untrusted mobile devices 626. In response to the unlock request 610, the server 612 sends one or more secure certificates 634 to the mobile device 604 as shown at 630. The secure certificates 634 can include one or more of the one or more secure certificates 616 at the server 612. The mobile device 604 sends the one or more secure certificates 634 to the locking device 608 as shown at 638. The mobile device sends, to the locking device 608, a current time included in time information 654 as shown at 650. The mobile device can determine a current time by accessing a clock 642. For example, the mobile device 604 can include a clock 642 that is referenced to determine a current time, and the current time can be sent to the locking device 608. In some implementations, the mobile device 604 can send information to the locking device 608 that can be included in one or more logs 668 including but not limited to date information, user information, a device profile, a device location, or other information from the mobile device. In some implementations, the mobile device 604 can include one or more computing systems 644 which can be implemented using the computing system 1000 in FIG. 10. In some implementations, the mobile device 604 can include one or more cameras 646. For example, the mobile device can include functionality to capture images and/or scan images using one or more cameras. In some implementations, the mobile device 604 can include one or more scanners 640 for scanning information. For example, the mobile device 604 can include a laser scanner, QR code scanner, or other scanner. In some implementations, the mobile device 604 can include one or more communications interfaces 648 (e.g., Near-Field Communication (NFC), Bluetooth®, Bluetooth® Low Energy (LE), WiFi, wireless Ethernet, cellular, etc.) that can be used to send and/or receive communications from one or more devices such as server 612 and/or locking device 608. In some implementations, the mobile device 604 can include a mobile computer. In some implementations, the mobile device can be a handheld device or other mobile device.

In the exemplary implementation of FIG. 6, the locking device 608 can receive, using an established wireless connection, communications including but not limited to the one or more secure certificates 634 and the time information 654 from the mobile device 604 as shown at 638. In some implementations, a short-range wireless connection, for example, can be established and used to send and receive wireless communications between the mobile device 604 and the locking device 608. In some implementations, wireless connections can include but are not limited to one or more short-range radio technologies (e.g., Bluetooth®), Near-Field Communication (NFC), or other short-range wireless connection. The locking device 608 can include one or more communications interfaces 676 that can be used to communicate with the mobile device 604. In some implementations the locking device can include a digital locking device or other electronic locking device. In one exemplary implementation, the locking device 608 includes one or more locking mechanisms 664 for locking and unlocking the locking device. In some implementations, the locking mechanism can include one or more of a physical locking mechanism, a magnetic locking mechanism, an electronic locking mechanism, or other locking mechanism.

The locking device 608 evaluates the unlocking request credentials provided by the mobile device to determine if it should be unlocked for a user to access inventory it is securing. The locking device 608 can evaluate the unlock request and credentials as described herein. For example, the process 300 in FIG. 3. can be included in the locking device evaluating the unlock request and credentials provided by the mobile device 604. In some implementations, the locking device 608 can include one or more computing systems 672 as described herein including one or more processors and computer-readable memory storing instructions. In some implementations, the locking device 608 can include one or more power sources 674. For example, the locking device 608 can include a battery or other power source. In evaluating the unlock request, the locking device 608 can use one or more of the one or more secure certificates 634, the time information 654, encryption information 658, a prior unlock time 660, one or more rules 662 (e.g., unlocking rules), or other information. After the locking device 608 unlocks in response to the unlock request, the locking device can send one or more logs 668 of past unlockings to the mobile device 604 as shown at 678. After receiving the one or more logs 668, the mobile device 604 can send the one or more logs 668 to the server 612 as shown at 680. The server 612 can store the one or more logs 668 with one or more other received logs 684. The server 612 can also store one or more authorization logs 688 that include information about prior authorization credentials in response to prior unlock requests.

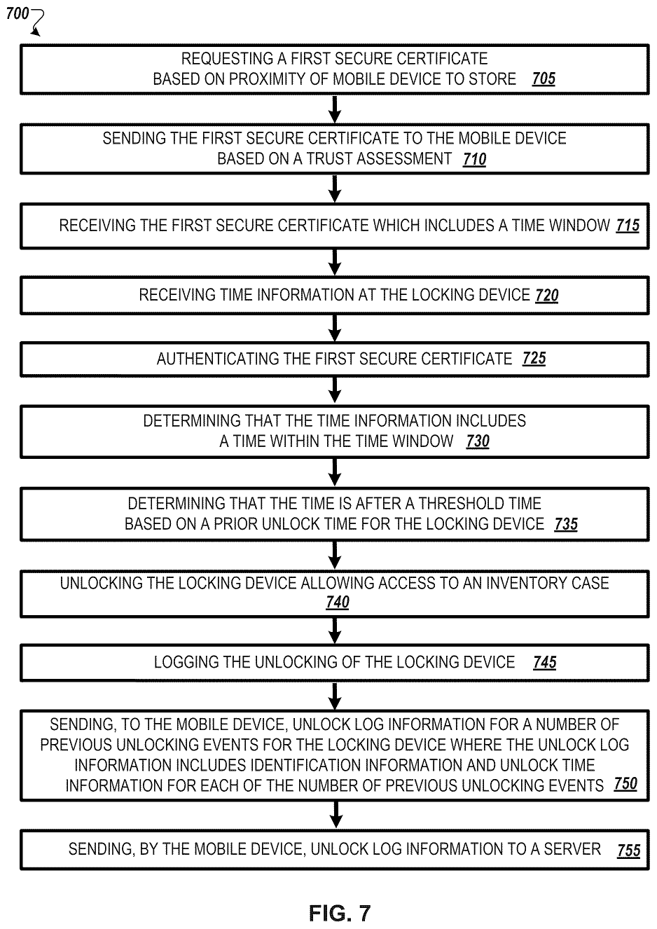

FIG. 7 is a diagram that shows an exemplary process 700 for unlocking a locking device for securing inventory. The exemplary process 700 can be performed using a computing system, as described and depicted herein. For example, the process 700 can be performed by the computing system 1000 in FIG. 10. In the exemplary embodiment of FIG. 7, at 705, a first secure certificate is requested by a mobile device based on the proximity of the mobile device to a store. At 710, the first secure certificate is sent to the mobile device based on a trust assessment. At 715, the first secure certificate which includes a time window. The first secure certificate can be received at a locking device from the mobile device using a wireless connection. At 720, time information sent from the mobile device is received at the locking device. At 725, the first secure certificate is authenticated. At 730, it is determined by the locking device that the time information includes a time within the time window. At 735, it is determined by the locking device that the time is after a threshold time which can be based on a prior unlock time for the locking device. At 740, the locking device is unlocked allowing access to the inventory case. At 745, the unlocking of the locking device is logged. At 750, unlock log information is sent to the mobile device for a number of previous unlocking events for the locking device. The unlock log information can include identification information and unlock time information for each of the number of previous unlocking events. At 755, the unlock log information is sent to a server by the mobile device. In some implementations, untrusted mobile devices and/or users are identified by the server based on the unlock log information. For example, a trusted server can compare stored prior logs for previous unlocking events with the currently received logs to determine if one or more mobile devices failed to send unlock log information after an unlocking event. An identified mobile device that failed to transmit unlocking logs can be identified as an untrusted device. A user associated with an untrusted mobile device can be identified as an untrusted user.

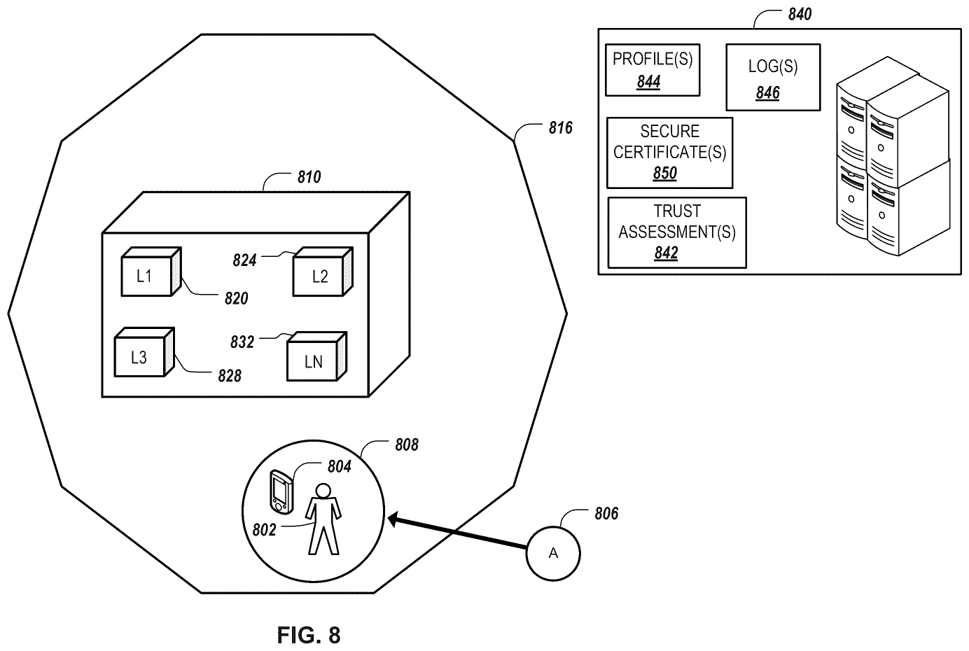

FIG. 8 is a diagram that shows an example of receiving authentication credentials for unlocking one or more locking devices based on the proximity of a mobile device to a retail store. In the example of FIG. 8, a user 802 with a mobile device 804, moves from the position shown at 806 which is beyond a threshold proximity 816 from the retail store 810 to the position shown at 808. The position shown at 808 is within the threshold proximity 816 to the retail store 810. In some implementations, the mobile device can detect that it is within the threshold proximity 816 to the retail store 810, and then can request authentication credentials from server 840 to unlock one or more locking device included in the retail store 810 including locking devices 820, 824, 828, and 832. In some implementations, the proximity of the mobile device 804 can be detected including using any of a variety of technologies including GPS, wireless networks, wireless communications, or the like. In some implementations, the threshold proximity is a proximity to a location within the retail store. For example, the threshold proximity can be when a user and mobile device enter the retail store or other area of the retail store. In response to the request for authentication credentials, the server 840 can provide one or more secure certificates 850 for unlocking the one or more locking devices included in retail store 810. In some implementations, the server 840 can use one or more of one or more trust assessments 842, one or more user profiles 844, one or more locking device logs 846, or other information in determining to provide the one or more secure certificates 850. In some implementations, a specific secure certificate can be used to open an individual locking device. In other implementations, a specific secure certificate can be used to open more than one locking device. For example, a user with a mobile device can enter a retail store and the mobile device can receive the unlocking credentials such as secure certificates for one or more of the locking devices in the retail store.

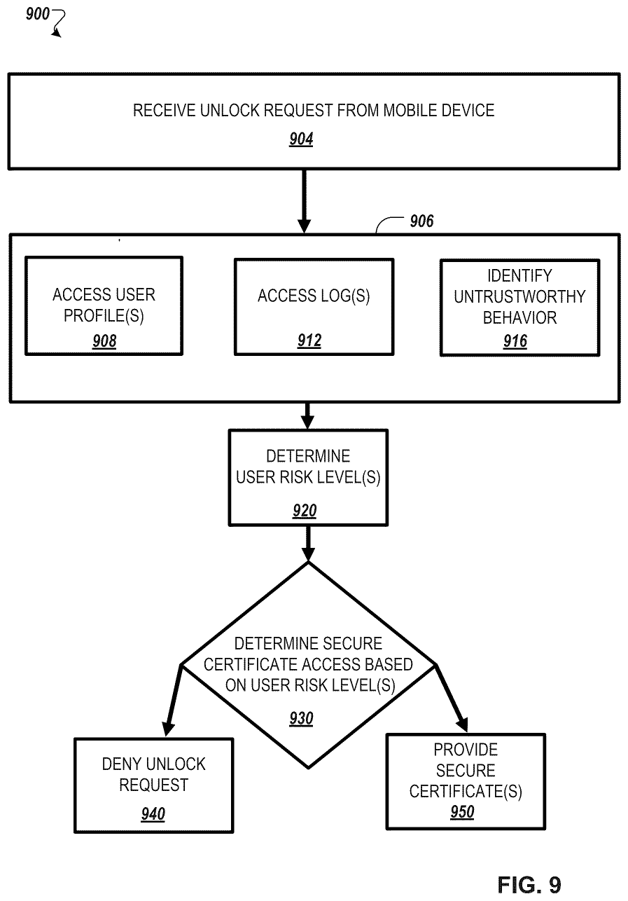

FIG. 9 shows a diagram of an exemplary process 900 for a trust assessment for determining access to unlocking credentials. In the example implementation of FIG. 9, at 904 an unlock request is received at a trusted server for unlocking credentials for one or more locking devices such as a locking device securing inventory. The trust assessment of the trusted server can include evaluating user information 906 which includes one or more of accessing one or more user profiles 908, accessing one or more logs 912, or identifying one or more untrustworthy behaviors 916. In some implementations, a user profile for example can include information about a user that can be used to determine the trustworthiness of the user. In some implementations a user can be a customer of a retail store and the user profile can include information about the customer including if the customer is a member of a membership program for the retail store, if the customer is a paid member of a membership program for the retail store, if the customer's identify has been verified, if the customer has provided credit card information to the retail store, a background check of the customer, if the customer has signed up for a program of the retail store, payment methods provided by the customer, financial information of the customer, or other information about the customer. In some implementations, the accessing one or more logs 912 can include locking device logs, prior authorization logs, or other logs. In some implementations, the identifying untrustworthy behavior 916 can include using information about a user to determine if the user is associated with prior suspicious activity including theft, accessing inventory cabinets using a mobile device that does not provide logs, or other suspicious activity. In some implementations, camera information can be correlated with the user's activity to determine untrustworthy behavior. In some implementations a user can be a worker (e.g., retail store worker) and the user profile can include information about the worker including if the worker is signed into a trusted account, if the worker is working during scheduled work hours, if the worker is using a trusted mobile device, or other information about the worker. For example, if a worker is signed into a trusted company work account on the mobile device and is working during scheduled work hours, then the worker can be given unlock access credentials to unlock locking devices securing inventory for the duration of the scheduled work hours. That is when the worker scans access code information for a locking device, the locking device can be unlocked based on the worker's information and user profile status using unlocking credentials sent from a secure server.

At 920, one or more user risk levels is determined for a user. For example, a level of risk of trusting the user can be determined for the user requesting the unlocking credentials based on the evaluated user information 906. In some implementations, a lower user risk level can indicate that a user can be provided access credentials to locking devices securing inventory that is more restricted and/or valuable. In some implementations, a higher user risk level can indicate that a user can be provided access credentials to locking devices securing inventory that is less restricted and/or less valuable. In some implementations, the determination of a user risk level can include determining an activity of a user. For example, an employee user can have a mobile device with a mobile application that is trusted and based on the user being an employee using a trusted application, the risk level for the employee can be below a threshold level that would allow the employee unlock access to one or more secured inventory cases while working in the retail store. In another implementation, of determining an activity of a user, for example, an employee user can be given a risk level based on an activity known in the employee's profile. For example, the employee's profile can include information of a work task including restocking or a picking list that includes inventory in one or more secured inventory cases, or other work task and the risk level can be based on the employee's duties while working at the store. In some implementations, an employee can be denied access to an inventory case based on an activity that does not correlate with a work duty that indicates a high risk level. At 930, a determination is made if one or more secure certificates are provided in response to the unlock request based on the one or more user risk levels. In some implementations, if a user risk level is below the designated threshold for allowing access to an inventory case secured by a locking device, then one or more secure certificates can be provided based on the user risk level. In some implementations, if a user risk level is above the designated threshold for allowing access to an inventory case secured by a locking device then the unlocking request can be denied and no secure certificates are provided based on the user risk level. In some implementations, an inventory case secured by a locking device in a retail store can be associated with a threshold risk level and access to the inventory case can be granted or denied based on a comparison of a user risk level to the threshold risk level for the inventory case. In the example of FIG. 9, at 940, the unlock request can be denied. For example, secure certificates are not provided for the one or more locking devices denying a user access to the one or more inventory cases secured by the locking devices. At 950, one or more secure certificates can be provided in response to the unlocking request. For example, one or more secure certificates can be sent to the mobile device that sent the unlock request based on the determined access level based on the one or more user risk levels.

FIG. 10 is a schematic diagram that shows an example of a computing system 1000 that can be used to implement the techniques described herein. The computing system 1000 includes one or more computing devices (e.g., computing device 1010), which can be in wired and/or wireless communication with various peripheral device(s) 1080, data source(s) 1090, and/or other computing devices (e.g., over network(s) 1070). The computing device 1010 can represent various forms of stationary computers 1012 (e.g., workstations, kiosks, servers, mainframes, edge computing devices, quantum computers, etc.) and mobile computers 1014 (e.g., laptops, tablets, mobile phones, personal digital assistants, wearable devices, etc.). In some implementations, the computing device 1010 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1010, and an entire system can be made up of multiple devices communicating with each other. For example, the computing device 1010 can be part of a computing system that includes a network of computing devices, such as a cloud-based computing system, a computing system in an internal network, or a computing system in another sort of shared network. Processors of the computing device (1010) and other computing devices of a computing system can be optimized for different types of operations, secure computing tasks, etc. The components shown herein, and their functions, are meant to be examples, and are not meant to limit implementations of the technology described and/or claimed in this document.

The computing device 1010 includes processor(s) 1020, memory device(s) 1030, storage device(s) 1040, and interface(s) 1050. Each of the processor(s) 1020, the memory device(s) 1030, the storage device(s) 1040, and the interface(s) 1050 are interconnected using a system bus 1060. The processor(s) 1020 are capable of processing instructions for execution within the computing device 1010, and can include one or more single-threaded and/or multi-threaded processors. The processor(s) 1020 are capable of processing instructions stored in the memory device(s) 1030 and/or on the storage device(s) 1040. The memory device(s) 1030 can store data within the computing device 1010, and can include one or more computer-readable media, volatile memory units, and/or non-volatile memory units. The storage device(s) 1040 can provide mass storage for the computing device 1010, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1050 can include various communications interfaces (e.g., USB, Near-Field Communication (NFC), Bluetooth®, WiFi, Ethernet, wireless Ethernet, etc.) that can be coupled to the network(s) 1070, peripheral device(s) 1080, and/or data source(s) 1090 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth®, WiFi, or other such transceiver. In addition, a GPS (Global Positioning System) receiver module can provide location-related wireless data, which can be used as appropriate by device applications. In addition, an indoor positioning system (e.g., TARGET IPS) receiver module can provide location-related wireless data, which can be used as appropriate by device applications. The interface(s) 1050 can include a control interface that receives commands from an input device (e.g., operated by a user) and converts the commands for submission to the processors 1020. The interface(s) 1050 can include a display interface that includes circuitry for driving a display to present visual information to a user. The interface(s) 1050 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1070 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1010 can communicate with the peripheral device(s) 1080, the data source(s) 1090, and/or other computing devices over the network(s) 1070. In some implementations, the computing device 1010 can directly communicate with the peripheral device(s) 1080, the data source(s), and/or other computing devices.

The peripheral device(s) 1080 can provide input/output operations for the computing device 1010. Input devices (e.g., keyboards, pointing devices, touchscreens, microphones, cameras, scanners, sensors, etc.) can provide input to the computing device 1010 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1010 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1090 can provide data for use by the computing device 1010, and/or can maintain data that has been generated by the computing device 1010 and/or other devices (e.g., data collected from sensor devices, data aggregated from various different data repositories, etc.). In some implementations, one or more data sources can be hosted by the computing device 1010 (e.g., using the storage device(s) 1040). In some implementations, one or more data sources can be hosted by a different computing device. Data can be provided by the data source(s) 1090 in response to a request for data from the computing device 1010 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1090a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1090b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1090c. The machine learning system(s) 1090c, for example, can be used to analyze data from various sources (e.g., data provided by the computing device 1010, data from the data store(s) 1090a, data from the blockchain(s) 1090b, and/or data from other data sources), to identify patterns in the data, and to draw inferences from the data patterns. In general, training data 1092 can be provided to one or more machine learning algorithms 1094, and the machine learning algorithm(s) can generate a machine learning model 1096. Execution of the machine learning algorithm(s) can be performed by the computing device 1010, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents assessment information, profile information, or access information. The machine learning model that results from the machine learning algorithm(s) can be used to secure inventory. Use of the machine learning model can provide the benefit of efficiently securing inventory.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other. While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A locking device, the locking device comprising:
a locking device;
one or more processors; and
computer-readable memory storing instructions that, when executed by the processors, cause the processors to perform operations comprising:
receiving, at the locking device, a first secure certificate from a mobile device using a wireless network connection, wherein the first secure certificate includes a time window;
receiving, at the locking device, time information from the mobile device;
authenticating the first secure certificate by the locking device;
determining, by the locking device, that the time information corresponds with the time window;
determining, by the locking device, that the time information is after a threshold time, wherein the threshold time is based on a prior unlock time for the locking device; and
unlocking the locking device.

2. The locking device of claim 1, wherein the operations further comprise:
establishing a wireless connection with the mobile device.

3. The locking device of claim 1, wherein the locking device does not include a clock.

4. The locking device of claim 1, wherein the operations further comprise:
sending, to the mobile device, unlock log information for a number of previous unlocking events for the locking device, wherein the unlock log information includes identification information and unlock time information for each of the number of previous unlocking events.

5. The locking device of claim 1, wherein the prior unlock time is stored at the locking device based on a prior unlocking event.

6. The locking device of claim 1, wherein the operations further comprise:
logging the unlocking of the locking device, wherein the logging includes storing identification information and unlock time information at the locking device.

7. The locking device of claim 1, wherein the operations further comprise:
relocking the locking device based on determining that an inventory case has been accessed, wherein the locking device secures the inventory case.

8. The locking device of claim 1, wherein the authenticating the first secure certificate includes using a public key to verify an encrypted digital signature.

9. The locking device of claim 1, wherein the prior unlock time is further based on the time window included in the secure certificate.

10. A method of securing an inventory case, the method comprising:
receiving, at a locking device securing an inventory case, a first secure certificate from a mobile device using a wireless network connection, wherein the first secure certificate includes a time window;
receiving, at the locking device, time information from the mobile device;
authenticating the first secure certificate by the locking device;
determining, by the locking device, that the time information corresponds with the time window;
determining, by the locking device, that the time information is after a threshold time, wherein the threshold time is based on a prior unlock time for the locking device; and
unlocking the locking device allowing access to the inventory case.

11. The method of claim 10, wherein the method further comprises:
requesting the first secure certificate based on a proximity of the mobile device to a store.

12. The method of claim 10, wherein the method further comprises:
requesting a plurality of secured certificates based on the proximity of the mobile device to a store, wherein the first secured certificate is included in the plurality of secured certificates.

13. The method of claim 10, wherein the method further comprises:
sending, by a server, the secure certificate to the mobile device based on a trust assessment.

14. The method of claim 10, wherein the method further comprises:
sending, to the mobile device, unlock log information for a number of previous unlocking events for the locking device, wherein the unlock log information includes identification information and unlock time information for each of the number of previous unlocking events.

15. The method of claim 14, wherein the method further comprises:
based on the unlock log information, denying unlock access to an untrusted mobile device.

16. The method of claim 10, wherein the prior unlock time is stored at the locking device based on a prior unlocking event.

17. The method of claim 10, wherein the trust assessment includes correlating an activity with an inventory case.

18. The method of claim 10, wherein the trust assessment includes correlating a risk level with an inventory case.

19. The method of claim 10, wherein the time window is based on the trust assessment.

20. A method of securing an inventory case, the method comprising:
requesting, by a mobile device, a first secure certificate based on a proximity of the mobile device to a store;
sending the first secure certificate to the mobile device based on a trust assessment;
receiving, at a locking device, the first secured certificate from the mobile device using a wireless network connection, wherein the secured certificate includes a time window;
receiving, at the locking device, time information from the mobile device;
authenticating the first secured certificate by the locking device;
determining, by the locking device, that the time information includes a time within the time window;
determining, by the locking device, that the time is after a threshold time, wherein the threshold time is based on a prior unlock time for the locking device;
unlocking the locking device allowing access to the inventory case;
logging the unlocking of the locking device;
sending, to the mobile device, unlock log information for a number of previous unlocking events for the locking device, wherein the unlock log information includes identification information and unlock time information for each of the number of previous unlocking events; and
sending, by the mobile device, the unlock log information to a server.
